(19) United States
(12) Patent Application Publication
(10) Pub. No.: US 2009/0229553 A1
(43) Pub. Date: Sep. 17, 2009

(54) Engine System

(76) Inventor: Theodore C. Bililies, Natick, MA (US)

Correspondence Address: GREENBERG & LIEBERMAN, LLC, 2141 WISCONSIN AVE, N.W., SUITE C-2, WASHINGTON, DC, 20007, US

(21) Appl. No.: 12/045,621

(22) Filed: Mar. 10, 2008

Related U.S. Application Data
(60) Provisional application No. 60/894,080, filed on Mar. 9, 2007.

(51) Int. Cl. F01L 1/06; F02D 17/02

(52) U.S. Cl. 123/90.32; 123/198 F

(57) ABSTRACT

An adaptable cylinder deactivating system for automobile engines that can easily and cost effectively be placed into virtually any existing or new engine to drastically reduce fuel consumption. This outcome is achieved by deactivating half of the cylinders while also eliminating compression at times when full power is not necessary. Elliptical apparatuses are placed within two semi-circular supports on each piston of the automobile engine between the camshaft and intake and exhaust valves using solenoids to determine exact positioning to ultimately reduce gas consumption for most types of engines, including diesel, gasoline and injection engines.

This is a non-provisional application claiming priority to provisional patent application No. 60/894,080 filed on Mar. 9, 2007.

### FIELD OF THE INVENTION

The present invention relates primarily to an elliptical apparatus and method that is placed within two semi-circular supports on each piston of the automobile engine between the camshaft and intake and exhaust valves using solenoids to determine exact positioning to reach the ultimate result of deactivating selected cylinders during engine operation to significantly reduce gas consumption for most types of engines, including diesel, gasoline and injection engines.

### BACKGROUND OF THE INVENTION

We live in a highly mobile society. The vast majority of the population relies on automobiles to suit their ever-growing transportation needs. Whether it is large SUVs, pickup trucks, sports cars, sedans or virtually any other type of automobile on the market, people must pay ever fluctuating and uncertain fuel costs to keep moving. International disputes, the OPEC oil cartel and diminishing supply are only a fraction of the extraneous elements that affect the gas budgets of American automobile drivers. Even hurricanes have proven to affect costs. In short, fueling an automobile costs money. Compounding the road-related issues are the environmental factors. Emissions testing has become commonplace in many U.S. jurisdictions and not only affects manufacturers, but also individual automobile owners (new and used vehicles) as well. While hybrid automobile purchases have made some headway onto the market, Americans continue to stick with traditional automobiles with traditional engines. These engines typically come with 4, 6 or 8 cylinders that operate with opening and closing valves resulting in gas consumption at maximum power from the time that the automobile is turned on until the key is switched off. With traditional engines that dominate our roadways, the automobile engine cylinders continue to consume gas in similar amounts regardless of whether the automobile is accelerating and on the move or if it is idling during a traffic jam or cruising at a sustained speed. Various designers have recognized this issue and have made some costly, limited and relatively impractical attempts to better maximize the gas consumption levels created by the operation of the engine. People have recognized that it is unnecessary to have all cylinders consuming fuel during such times as cruising and idling. During these instances, only half of the cylinders need to be consuming fuel to keep the automobile operating. If only half of the cylinders are consuming fuel, then this creates a scenario where fuel consumption is reduced by 50 percent during those times. Moreover, if fuel consumption is reduced by half, then environmental emissions also are reduced by half. These drastic reductions would have significant impacts on the consumer pocketbook as well as environmental ramifications. However, attempts to achieve these goals have proven to be inadequate or inefficient and have run into the problem of not being cost effective in the design and methodology. For example, a driver of an automobile featuring a carburetor engine would have no reasonable recourse under current attempts to refit his or her engine to create a situation of drastically reduced fuel consumption. Other attempts to significantly decrease gas and fuel consumption of automobiles include the use of two engines. Some hybrids feature one electric engine and one gasoline. The Jeep Hurricane concept also appeared in 2005 with two Hemi engines—one in the front and one in the back. However, the obvious issues with these additional attempts are that they require drivers to purchase new automobiles featuring two engines in order to gain significantly reduced gas consumption. However, these reductions are not that significant, the hybrid automobiles need either gas or electricity to function, and both sources of energy are extraordinarily costly.

Therefore, there is a need for a durable system that can cost-effectively and safely deactivate half of the engine's cylinders contained in virtually all existing automobile engines in order to maximize fuel economy by about 50 percent while avoiding wear-and-tear issues. A related need relates to the fact that automobile engines need such a system to be capable—automatically if necessary—of eliminating compression that is normally created as a result of the closing of the cylinders. This type of system could single-handedly reduce by up to 50 percent the gas consumption and environmental emissions that result from the operations of the usual automobile engines. By placing such a system onto new and old engines in such a relatively simple manner, the benefits would be enormous in terms of cost, environment and more. The need to remedy such issues is widely known, but many attempts to rectify the issue have proven costly, inconvenient and wholly impractical. It should be noted that none of these inventions have been implemented by the manufacturers. This has kept the need for such a durable system open. In addition, this need applies to not only standard gasoline engines, but also diesel and injection engines as well. As described below, nothing else compares with the unique aspects of the present invention.

U.S. Pat. No. 4,414,935 issued to Curtis on Nov. 15, 1983, is a device that uses a number of moving parts, including rocker arms and rocker balls among others, to deactivate certain cylinders. Unlike the present invention, this device is subject to deterioration and other issues—including increased cost and complicated installation—based on the fact that it requires numerous movable parts to deactivate the valves as opposed to relative simplicity and efficiency. Additionally, the de-activation of the cylinders, when using this device, generates compression, resulting in negative or loss of force.

U.S. Pat. No. 4,175,534 issued to Jordan on Nov. 27, 1979, is a device that uses a number of moving parts including rocker arms to help control the engine and deactivate certain cylinders. Unlike the present invention, this device is subject to deterioration and other issues—including increased cost and complicated installation—based on the fact that it requires numerous movable parts and complicated sensors to deactivate the valves as opposed to relative simplicity and efficiency. In addition, unlike the present invention, the complex array of moveable parts of this device does not substantially limit the loss of force due to compression in the cylinder.

U.S. Pat. No. 6,553,962 issued to Russ on Apr. 29, 2003, is a device that uses a number of moving parts and sensors to close off fuel to the engine during deceleration and also to cause engine braking. Unlike the present invention, this device features many more moveable parts and cannot be installed and applied to existing engines. Additionally, the de-activation of the cylinders, when using this device, generates compression, resulting in negative or loss of force.

U.S. Pat. No. 6,814,040, issued to Hendriksma on Nov. 9, 2004, is a device that employs a specifically constructed pin to help deactivate certain cylinders of the engine. Unlike the present invention, this device relies on pins surrounded by small parts and is designed almost solely for manufacturers and is not meant to be applied to existing engines. Additionally, the de-activation of the cylinders, when using this device, generates compression, resulting in negative or loss of force.

U.S. Pat. No. 6,994,069, issued to Hasebe on Feb. 7, 2006, is a hydraulic control device that uses a number of moving parts to deactivate certain cylinders. Unlike the present invention, this device has a multitude of small parts that engage a number of complicated endeavors such as involving hydraulic elements and oil pressure that limits this device to newly manufactured automobiles and is not meant to be installed onto existing engines. Additionally, the de-activation of the cylinders, when using this device, generates compression, resulting in negative or loss of force.

A need has been established for system that can be installed on both existing and newly manufactured engines in a relatively simple manner with the effect of deactivating half of the cylinders when full power is not required. Unless the automobile is accelerating or otherwise in need of power, it is effectively a waste of gas consumption to have all cylinders continue the process of fuel combustion. Moreover, while the idea of deactivating half of these cylinders can save substantial amounts of money in fuel costs, another practical need has developed in regard to those who cannot or do not wish to purchase an entirely new automobile. The present invention uniquely satisfies this need based on not only its cost-effective design and practical effectiveness in automatically deactivating half of the cylinders under the aforementioned conditions, but the present invention also can be installed onto the cylinders of virtually any existing engine at low cost. This factor also contributes to the need for continued engine durability. The design of the present invention is adaptable and simple enough that it can easily change to different cylinders in order to lessen wear and tear and enhance longevity. Therefore, the present invention satisfies the need for a cost-effective cylinder deactivation device that can have the effect of reducing gas consumption and environmental emissions by about 50 percent.

### SUMMARY OF THE INVENTION

The present invention achieves the intended effect of deactivating the fuel consumption of certain selected cylinders with the use of elliptical apparatuses that are placed in various positions over each selected valve. More directly, when the elliptical apparatus is placed above the intake valve in a horizontal position, it prevents the entrance of gasoline and thus results in no fuel consumption. Moreover, fuel is permitted to enter when the elliptical apparatus is placed in a vertical position. The elliptical apparatuses can be easily attached by someone possessing even the lower levels of engine mechanical aptitude through the use of solenoids. The elliptical apparatus is placed between the camshaft and the intake and exhaust valves. Typically, the elliptical apparatuses will be positioned so that half of the engine's cylinders would be actively working while the other half would be deactivated when full engine power is not needed. The elliptical apparatuses and solenoid installation is simple and cost efficient enough where they can easily be removed from the originally selected cylinder placement and switched in order to utilize each end of the engine evenly and avoid rapid deterioration that can be caused by using the same pistons all the time. In addition, the deactivation of the valves does not cause compression so there is no loss of force. The process of deactivation is seamless and can automatically allow full power at times such as acceleration when all cylinders are needed.

The present invention does not just apply to standard gasoline engines. Diesel and injection engines may differ in some aspects, but reap the same benefits when applied to the present invention. Injection engines are very similar to the carburetor engines. The difference resides in the fact that the carburetor engines use a manifold to supply fuel to all cylinders. The manifold is the connection between the carburetor and the cylinder. In order to achieve the substantial savings in fuel consumption as mentioned above, activating the elliptical apparatus of the present invention that are placed over the valves interrupts the fuel supply to provide the desired consumption results.

The injection engines have a pump (either mechanical or electronic) that supplies the fuel through the manifold, and that fuel is injected straight into the combustion chamber above the piston by using injectors. These types of engines need a spark plug to ignite the fuel and air mixture. Similar to the carburetor engines, the elliptical apparatus is placed over all valves to deactivate the fuel supply.

In regard to diesel injection engines, these are compression ignition engines in which the fuel ignites as it is injected into the engine. Moreover, diesel engines generally have high compression ratios to enable compression ignition although diesel engines do not need a spark plug in order to cause igntion.

To deactivate the piston in relation to the present invention, a simple valve is placed in the pipe to redirect the fuel to another injector. This injector typically easily opens and returns the fuel back to the tank. Only one elliptical apparatus of the present invention is needed over the exhaust valve as the air that enters into the intake valve does not cause combustion due to lack of fuel and low compression.

### BRIEF DESCRIPTION OF THE DRAWINGS

FIG. 1 is a view of the present invention in respect to the placement and function of various elements.

FIG. 2 is a cross-section view of the present invention attached to a typical 4-cylinder engine showing positions of all relevant parts.

FIG. 3 is a view of the present invention as it pertains to fuel injection engines.

FIG. 4 is a side view of the present invention in respect to movement of the intake valve and exhaust valve that are moved by the rocker arm.

FIG. 5 is a side view of the present invention in respect to the rocker arm for either two intake valves or two exhaust valves.

For purposes of brevity and clarity, like components and elements of the present invention and typical engine will bear the same designations or numbering throughout the following description and drawings.

### DETAILED DESCRIPTION OF THE PREFERRED EMBODIMENT

I. The Parts

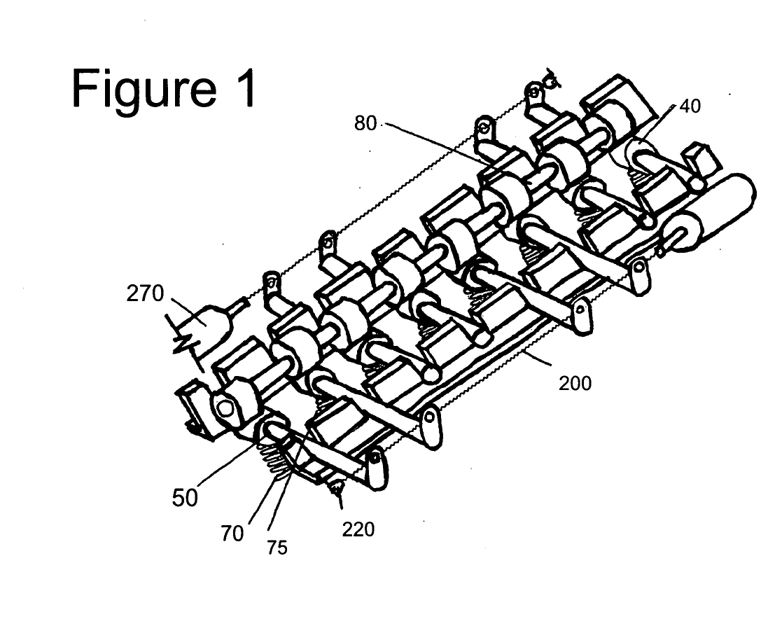

In FIG. 1, we see the elliptical apparatus (40) and function of the solenoids (220) attached to a typical four-cylinder engine. The size is structured so that it fits as a component of a transversal rotational axial bar (50) on top each piston (60).

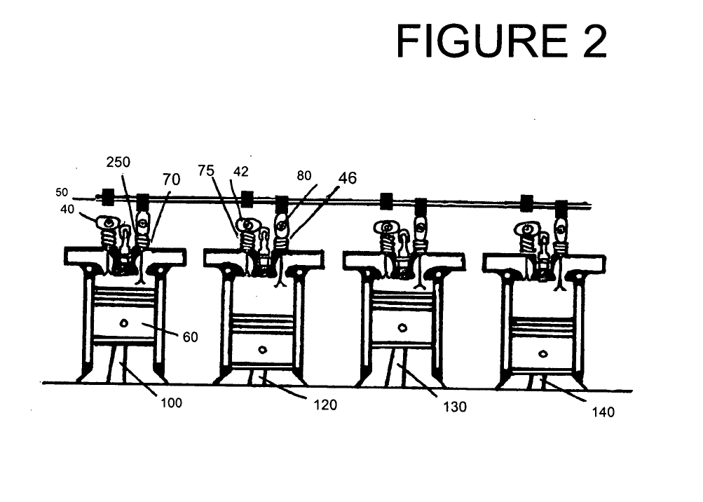

In FIG. 2, we see the various elements of the present invention as it would look under typical 4-cylinder engine conditions, including the placement of the elliptical apparatuses (40) in horizontal (42) and vertical (46) positions between the respective intake valves (70) and camshaft (80).

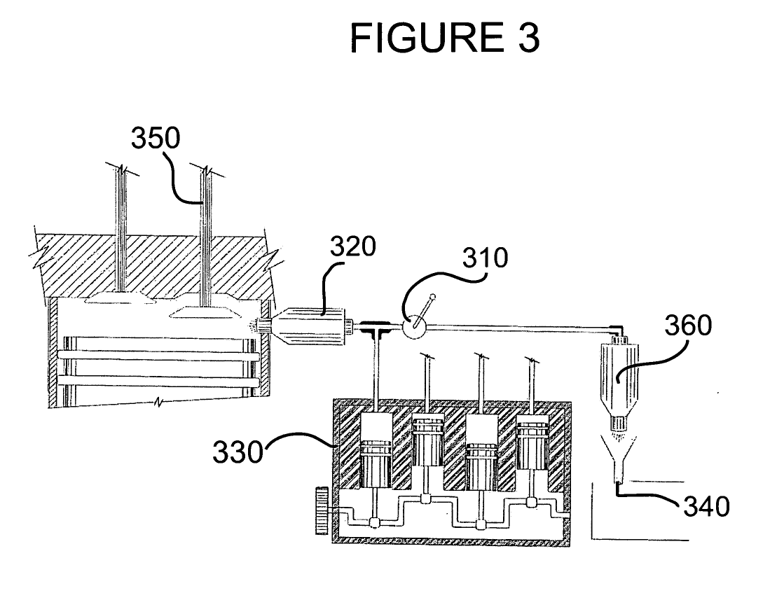

In FIG. 3, we see an additional embodiment of the present invention in relation to how it applies to fuel injection engines. Fuel injection engines contain some different physical elements and placements compared to carburetor engines. This includes the fuel injection valves (350), high-pressure injector (320), pressurized fuel valve (310), low-pressure injector (360), high-pressure pump (330) and the fuel tank (340).

II. The Usage

Overall, the elliptical apparatuses (40) are placed within two semi-circular supports on each piston (60) of the automobile engine between the camshaft (80) and intake valves (70) and exhaust valves (75) using solenoids (220) to determine exact positioning to ultimately reduce gas consumption for most types of engines, including diesel, gasoline and injection engines.

The basic installation of the present invention is relatively simple and requires only minimal work. The present invention is installed onto the engine first by elevating the camshaft (80). Once the camshaft (80) is elevated, the elliptical apparatus (40) is placed between the camshaft (80) and adjacent intake valve (70). It should be noted that these elliptical apparatuses (40) are built-in a transversal rotational axial bar (50) located on top of each piston (60).

In the example of the typical 4-cylinder engine, the order from which combustion starts begins with the first cylinder (100), then the third cylinder (130), then the fourth cylinder (140) and finally combustion ends with the second cylinder (120). Because the desired effect of the present invention in respect to the typical 4-cylinder engine is to maintain regular gas consumption with only two cylinders rather than all four cylinders, the placement of the elliptical apparatuses (40) over each intake valve (70) is vital. When the first cylinder (100) and third cylinder (130) are operating under normal power, the elliptical apparatus (40) is placed vertical (46) over the intake valve (70), permitting gas to enter the first cylinder (100). However, in order to impede the entrance of gas into the fourth cylinder (140) and second cylinder (120) by maintaining closed intake valves (70), the elliptical apparatus (40) is placed horizontal.

What results from these placements is that an elliptical apparatus (40) is placed vertical (46) over the intake valve (70) and an elliptical apparatus (40) is placed horizontal (42) over an exhaust valve (75). This allows for the air compression and gas mixture to occur in relation to the first cylinder (100) and third cylinder (130), achieving the necessary force of the engine based on the resulting combustion. Once this compression and combustion occur, the exhaust valves (75) open and release the gas. At the same time, when the elliptical apparatuses (40) are horizontal (42) over the intake valve (70) and the other elliptical apparatus (40) is vertical (46) over the exhaust valve (75), the fourth cylinder (140) and second cylinder (120) get deactivated so to speak, meaning that the exhaust valves (75) remain open to allow free movement and subsequently avoid unnecessary compression against the force. The end function is that half of the cylinders are controlled or deactivated during those many times when full power and acceleration is not necessary. In respect to the typical 4-cylinder engine, the first cylinder (100) and third cylinder (130) continue to operate normally, while the fourth cylinder (140) and second cylinder (120) will continue to be in motion but will not cause combustion or compression.

Based on the design and intention of the present invention, the sequence can be relatively easily changed. For example, instead of the aforementioned scenario, the present invention can be switched to maintain the fourth cylinder (140) and second cylinder (120) at full power and combustion while the first cylinder (100) and third cylinder (130) can easily be deactivated. Of course, the present invention works with typical 4 cylinder, 6 cylinder and 8 cylinder engines.

Perhaps this adaptability is complemented by the method of design and installation of the present invention. As mentioned, the installation process begins with elevating the camshaft (80). The elliptical apparatuses (40) are placed according to their selected function by tying in the desired cylinder sequence. In our example, the first cylinder (100) is connected to the third cylinder (130) while the fourth cylinder (140) is connected to the second cylinder (120). These connections are made possible by a flexible cable (200) that is moved by the solenoids (220, 270). In addition, the lids (250) that cover the intake valves (70) need to be elevated as well. The control of these positions is achieved by two solenoids (220, 270) that serve to pull the flexible cable (200) to the desired direction with the aid of the solenoids (220, 270).

Meanwhile, the elliptical apparatuses (40) vertically move due to the spring motion of the intake valves (70) and exhaust valves (75). Still, the elliptical apparatuses (40) are held in fixed positions by a transversal rotational axial bar (50) and its extremes are fixed by the flexible cable (200) where the solenoids (220, 270) permit longitudinal movement. When the gas descends to the pistons (60), the gas is not absorbed as the intake valve (70) remains closed. However, as mentioned above, the pistons (60) will remain in motion as the exhaust valve (75) remains open, thus avoiding compression. In respect to the distributor, it will function without any kind of alteration as the deactivated cylinders cannot generate combustion based on the predetermined positioning of the present invention. It also should be noted that lubrication does not change with implementation of the present invention because the characteristics of the engine are not altered.

While the physical attributes are different in terms of parts and placement, the present invention ultimately achieves the same desired benefits in regard to fuel injection engines as seen in FIG. 3. A primary difference between fuel injection engines and carburetor engines is that fuel injection engines operate a high-pressure pump (330) that serves to supply fuel through the manifold where the fuel is ultimately injected into the combustion chamber above the piston through the use of the high-pressure injector (320) and low-pressure injector (360). Just like the procedure for carburetor engines, simple placement of an elliptical apparatus (40) over the fuel injection valves (350) will deactivate the fuel supply and achieve the goal of significantly decreased fuel consumption.

Primarily, the present invention is a necessary and useful system that deactivates half of the engine's cylinders at times when full power is not necessary. The result of the installation and use of the present invention is that an automobile can smoothly function like normal, but while maximizing fuel economy by about 50 percent. At the same time, environmental emissions also will be drastically reduced. The benefits to the driver and environment are enormous. In addition, the process of deactivation engaged in by the present invention is seamless and can be automatic or manual as the automobile takes to the road. When less power is needed, the automobile can smoothly function at 50 percent of its normal power. Examples of this include times when the automobile has reached a certain level of speed such as while cruising, traffic jams, idling or decelerating. Since full engine power is not needed during these times, deactivation emanating from the present invention maximizes fuel economy. And when more power is needed for is for starting the automobile, driving on different terrains and during acceleration, the present invention permits for the automatic transition to the use of all cylinders. But besides the benefits to fuel economy, the present invention also is necessary based on the fact that is can be installed to existing engines in a very cost-effective manner.

III. The Rocker Arm

The above description and figures detailed the present invention in its simplest form in regard to the placement of the camshaft (80) over the valves. The preferred embodiment of the present invention also may include a rocker arm (400). The rocker arm (400) is a handle that aids in the lowering of the intake valve (70) or the exhaust valve (75). When the camshaft (80) gyrates, the spring on either the intake valve (70) or the exhaust valve (75) is in charge of returning the intake valve (70) or exhaust valve (75) to its initial position. The rocker arm (400) can be compared to a seesaw, where one end is being pushed upward and the other end gets pushed downward.

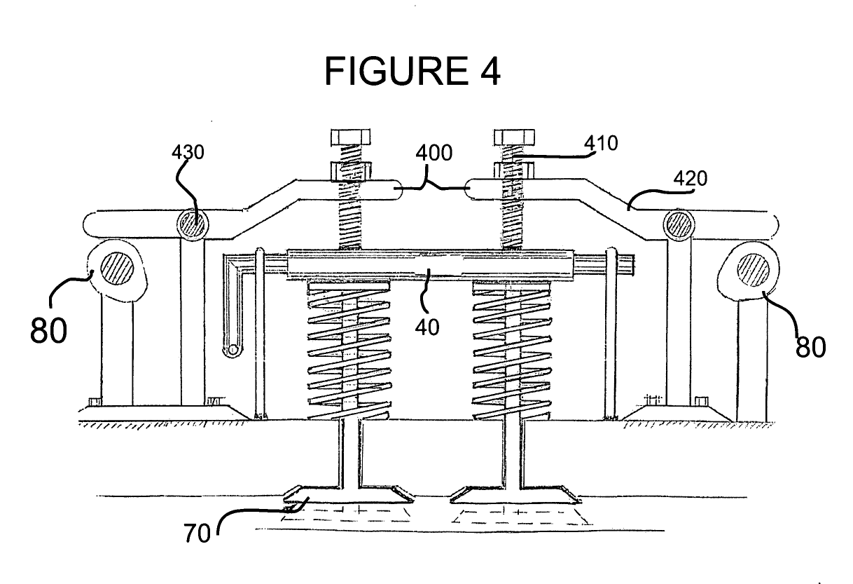

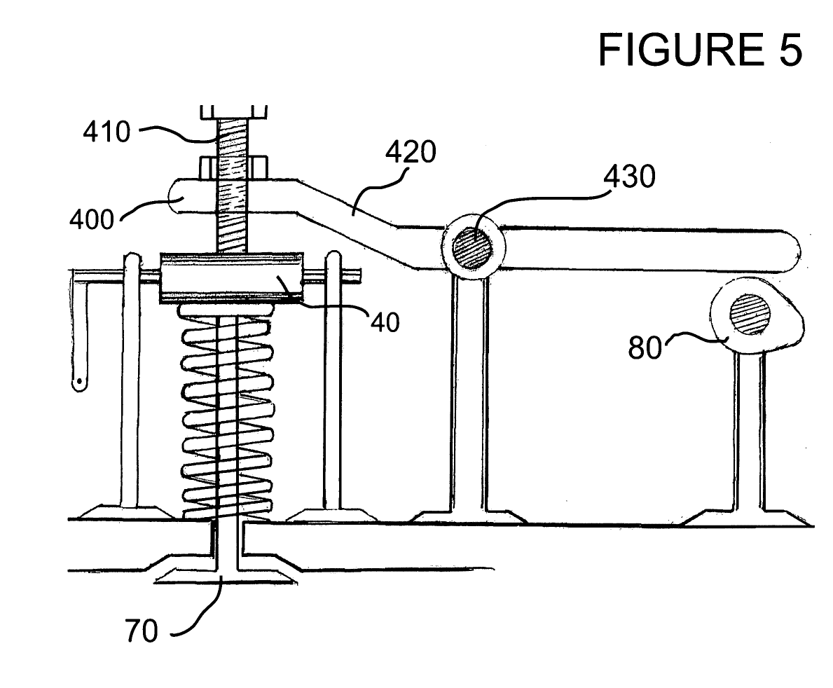

In essence, the rocker arm (400) corrects the simplicity of the designs described in FIG. 1, FIG. 2 and FIG. 3. It should be noted that the previous figures do not include the rocker arm (400) in order to better convey the function of the present invention. FIG. 4 and FIG. 5 relate to the stated function of the present invention while also including the rocker arm (400) of the present invention. On one end of the rocker arm (400) is an adjustor screw (410). The adjustor screw (410) regulates the separation, which is measured in the thousandths of an inch, so that either the intake valve (70) or exhaust valve (75) settles completely into its base to fully achieve its function either in a completely open or completely closed manner as necessary based on the above description.

The elliptical apparatus (40) is placed over the intake valve (70) and exhaust valve (75), just as displayed in FIG. 1, FIG. 2 and FIG. 3, where the camshaft (80) is directly pushing the intake valve (70) and exhaust valve (75) downward. However, FIG. 4 and FIG. 5 demonstrate how the rocker arm (400) is pushing down the intake valve (70) and exhaust valve (75) even though the elliptical apparatus (40) is still placed over the intake valve (70) and exhaust valve (75). In that way, there is no need to modify the height of the fulcrum (430) relating to the camshaft (80) or the rocker arm (400). It also is not necessary for this height to be equal to the height of the elliptical apparatus (40) when it is in a horizontal position.

By leaving the camshaft (80) and the fulcrum (430) at their original heights, it is necessary that an upward fold (420) of the rocker arm (400) provide the space needed to host the elliptical apparatus (40). The size of the fold (420) of the rocker arm (400), which goes over the exhaust valve (75), will be equal to the smallest diameter of the elliptical apparatus (40). The fold (420) size of the rocker arm (400), which goes over the intake valve (70), will be equal to the largest axis of the elliptical apparatus (40). In other words, the height of the fold (420) in the rocker arm (400) that is placed over the exhaust valve (75) will be equal to the smallest diameter of the elliptical apparatus (40). This means that there will be two sizes for the folds (420), the largest is on the rocker arm (400) over the intake valve (70)—as shown in FIG. 4—and the smallest one is on the rocker arm over the exhaust valve (75). It should be noted that FIG. 4 shows dual intake valves (70).

The differences in sizes are based on the coordinated movement of the intake valves (70) and exhaust valves (75). When the cylinder is active, the elliptical apparatus (40) over the exhaust valve (75) is in a horizontal position, and the elliptical apparatus (40) on the intake valve (70) is in a vertical position. The opposite occurs when the cylinder is inactive. In that case, the elliptical apparatus (40) on the exhaust valve (75) is in a vertical position, and the elliptical apparatus (40) on the intake valve (70) is in a horizontal position.

Relating to fuel-injection engines—either gasoline or diesel—all that is required is a single elliptical apparatus (40) over the exhaust valve (75). This is because when the cylinder is inactive, there is no combustion as the low-pressure injector is open, and thus, there is no fuel. The elliptical apparatus (40) over the exhaust valve (75) is needed so as to not generate compression by the exhaust valve (75) always being open and expelling air that enters through the intake valve (70). In fuel injection engines, the height of the fold (420) of the rocker arm (400) will be equal to the diameter of the elliptical apparatus (40) that is in a horizontal position.

It is to be understood that the present invention is not limited to the sole embodiment described above but is any and all embodiments within the scope of the following claims.

I claim:

1. An engine system, comprising:
placing elliptical apparatuses between a camshaft and intake valves;
placing elliptical apparatuses between the camshaft and exhaust valves;
deactivating cylinders by turning the elliptical apparatuses such that the elliptical apparatuses are longer horizontally than vertically over the intake valves; and
deactivating cylinders by turning the elliptical apparatuses such that the elliptical apparatuses are longer vertically than horizontally over the exhaust valves.

2. The engine system of claim 1, further comprising turning the elliptical apparatuses with a solenoid.

3. The engine system of claim 1, further comprising arranging the elliptical apparatuses such that the elliptical apparatuses are longer horizontally than vertically over the intake valves for two cylinders.

4. The engine system of claim 1, further comprising arranging the elliptical apparatuses such that the elliptical apparatuses are longer vertically than horizontally over the exhaust valves for two cylinders.

5. The engine system of claim 4, further comprising arranging the elliptical apparatuses such that the elliptical apparatuses are longer horizontally than vertically over the intake valves for two cylinders.

6. The engine system of claim 2, further comprising arranging the elliptical apparatuses such that the elliptical apparatuses are longer vertically than horizontally over the exhaust valves for two cylinders.

7. The engine system of claim 2, further comprising arranging the elliptical apparatuses such that the elliptical apparatuses are longer horizontally than vertically over the intake valves for two cylinders.

8. The engine system of claim 6, further comprising arranging the elliptical apparatuses such that the elliptical apparatuses are longer horizontally than vertically over the intake valves for two cylinders.

9. The engine system of claim 1, further comprising increasing the distance between the camshaft and the intake valves; and increasing the distance between the camshaft and the exhaust valves.

10. The engine system of claim 2, further comprising:
arranging the elliptical apparatuses such that the elliptical apparatuses are longer horizontally than vertically over the intake valves for two cylinder;
arranging the elliptical apparatuses such that the elliptical apparatuses are longer vertically than horizontally over the exhaust valves for two cylinders; and
increasing the distance between the camshaft and the intake valves; and increasing the distance between the camshaft and the exhaust valves.

11. An engine system, comprising:
placing elliptical apparatuses above exhaust valves; and
arranging rocker arms so that the height of the fold of the rocker arms is equal to the diameter of the elliptical apparatuses, the elliptical apparatuses arranged so that the elliptical apparatuses are longer horizontally than vertically.
